(19) United States
(12) Patent Application Publication
(10) Pub. No.: US 2025/0148289 A1
(43) Pub. Date: May 8, 2025

(54) SYSTEM AND METHOD OF LLM TRAINING FOR NETWORK STATE CONVERSATIONAL ANALYTICS

(71) Applicant: Aviz Networks, Inc., San Jose, CA (US)

(72) Inventors: Niloy Mukherjee, San Jose, CA (US); Chidambaram Bhagavathiperumal, Livermore, CA (US); Vishal Shukla, San Jose, CA (US); Rishab Arun Haltore, Washington, DC (US); Saksham Jain, Madison, WI (US)

(73) Assignee: Aviz Networks, Inc., San Jose, CA (US)

(21) Appl. No.: 18/539,067

(22) Filed: Dec. 13, 2023

Related U.S. Application Data
(63) Continuation-in-part of application No. 18/504,991, filed on Nov. 8, 2023.

(51) Int. Cl. G06N 3/0895; G06N 3/0475

(52) U.S. Cl. CPC G06N 3/0895; G06N 3/0475

(57) ABSTRACT

In some implementations, the method may include receiving, by one or more agent applications, a query from a user. In addition, the method may include providing a dataframe to the one or more agent applications. The method may include appending a predetermined number of initial entries from the dataframe to a suffix of the query. Moreover, the method may include constructing a standardized prompt template, where the query is embedded within the standardized prompt template. Also, the method may include Channeling the prompt template to one or more Large Language Models (LLMs). Further, the method may include Utilizing a GPT API to generate a generated code snippet. In addition, the method may include Executing the generated code snippet to create a resulting output. The method may include Relaying the resulting output back to the user.

### CROSS REFERENCE TO RELATED APPLICATIONS

The present application is a continuation-in-part of U.S. patent application Ser. No. 18/504,991, filed Nov. 8, 2023, the disclosure of which is entirely incorporated by reference herein.

### BACKGROUND

The advent of Generative AI, particularly by Large Language Models (LLMs), has initiated a transformative shift in application development and interpretation methodologies. Enhanced methods are necessary to bolster network management systems, equipping them with the ability to proactively identify issues, optimize network traffic, engage in strategic capacity planning, and accurately pinpoint security incidents.

This shift is ready to disrupt the conventional process of application development, traditionally reliant on human intellect and manual intervention at every juncture—from the initial phase of product conceptualization, through the intricacies of user experience and interface design, to the complexities of backend database architecture and execution. Existing application models necessitate users to navigate through multiple steps to derive insights, primarily focusing on field experts rather than strategic decision-makers. However, there is a growing demand for interfaces that can deliver critical insights to decision-makers in a direct and precise manner.

Consequently, there is an urgent need for advanced analytic methodologies. These methodologies should handle network telemetry data and also interpret it with high efficacy. Such technological advancements are crucial for evolving the network management workflows, especially considering the increasing volume and complexity of network telemetry data.

### SUMMARY

The present disclosure provides systems and methods that leverage Generative AI framework to build a co-pilot that would provide end-user quick insights on the state of their network infrastructure, where the intelligence is primarily derived from the large language model rather than manual intervention.

According to an embodiment, the system intakes network state data captured from the infrastructure, converts them into summaries, transforms them into training prompts for LLMs, and provides a simple conversational interface to get quick insights with an efficacy that reaches near human-level.

The present disclosure further provides a generative AI architecture that leverages the power of Large Language Models (LLMs) and the scalable infrastructure of the cloud native ecosystem to effectively process, analyze, and derive insights from long-term network telemetry data. Embodiments of the present disclosure provide systems and methods for creating generative AI frameworks on network state telemetry. The embodiments disclosed herein provide processes that increase the efficiency of a cloud native ecosystem to effectively process, analyze, and derive insights from long-term network telemetry data. It can be appreciated that embodiments of the present disclosure, by storing and analyzing data over a longer period and implementing the novel processing steps disclosed herein, can rapidly identify trends, patterns, and anomalies that might not be identifiable using conventional systems in the art in such a timely and efficient manner. The embodiments disclosed herein allow for more informed decision-making and proactive network management in the context of network telemetry.

Some implementations herein relate to one or more methods of LLM training for network state conversational analytics. For example, the method may include receiving, by one or more agent applications, a query from a user. The method may also include providing a dataframe to one or more agent applications. The method may furthermore include appending a predetermined number of initial entries from the dataframe to a suffix of the prompt. The method may in addition include constructing a standardized prompt template, where the query is embedded within the standardized prompt template. The method may moreover include channeling the prompt template to one or more Large Language Models (LLMs). Other embodiments of this aspect include corresponding computer systems, apparatus, and computer programs recorded on one or more computer storage devices, each configured to perform the actions of the methods.

The described implementations may also include one or more of the following features. The method may include specifying one or more pandas commands to execute to formulate an appropriate response to the user's inquiry. The method where the receiving further may include receiving processed data in CSV format. The method where the relating is performed post-execution. The method may include setting the temperature of one or more large language models to zero. Implementations of the described techniques may include hardware, a method or process, or a computer tangible medium.

### BRIEF DESCRIPTION OF THE DRAWINGS

Certain features may be illustrated as examples in the accompanying drawings and should not be considered as limitations. In these drawings, identical numbers indicate corresponding elements.

FIG. 1 illustrates a network environment of a network state data processing platform according to an embodiment of the present disclosure.

FIG. 2 is an implementation of a process architecture according to an embodiment of the present disclosure.

FIG. 3 is a flowchart of a process of creating a generative AI framework on network state telemetry.

FIG. 4 discloses a response from the Agent.

FIG. 5 is a flowchart of an example process.

FIG. 6 discloses an agent architecture according to an embodiment of the present disclosure.

FIG. 7 is a snapshot of training data according to an embodiment of the present disclosure.

FIG. 8 is a flowchart of an example process.

### DETAILED DESCRIPTION

The following descriptions of various embodiments refer to the accompanying drawings identified above. These drawings depict ways to implement the aspects described. However, other embodiments can be employed, and modifications in structure and function are permissible without veering away from the scope outlined in this document. The terminology and phrasing used in this document are meant for descriptive purposes and should not be seen as restrictive. Instead, every term is intended to be interpreted in its broadest sense and connotation. Words like “including” and “comprising,” along with their derivatives, are meant to cover not only the listed items but also their equivalents and additional items, expanding their scope and inclusivity.

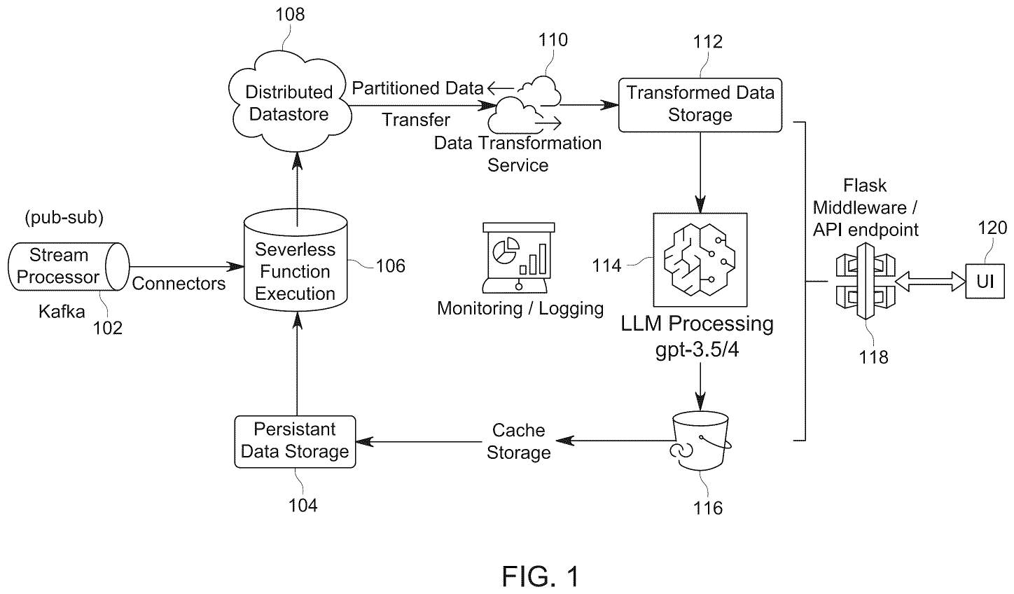

By way of example, FIG. 1 illustrates a network environment 100 of a network state data processing platform according to an embodiment of the present disclosure. Stream producer 102 is responsible for the generation and transmission of data to a designated stream or topic within the stream processing system. This data, which may take the form of events, messages, or records, is crucial for downstream applications' real-time processing and analysis.

Additionally, stream producer 102 is initiated for handling acknowledgments, enabling reliable message delivery, and can be equipped to manage various error scenarios that may arise during data transmissions. Stream producer 102 can efficiently manage high volumes of data and distribute it to multiple consumers.

According to an embodiment, producers specify the target partition for each message, thereby ensuring even distribution and parallelism. Additionally, the stream producer can address serialization requirements to efficiently encode data for storage and transmission. According to an embodiment, stream producer 102 continuously ingests, processes, and analyzes data in real-time, ensuring efficient handling of large volumes of streaming data. As data flows through the stream processor, it can be enriched and transformed before being forwarded to a serverless function 104.

Next, by utilizing event-driven architecture, serverless function 104 is triggered upon receiving data from the stream producer 102. This ensures optimal resource utilization as the function executes only when needed, scaling automatically to accommodate varying data volumes. Serverless function 104 is equipped with pre-defined logic to further process and format the data, preparing it for storage. It can be appreciated that the serverless function is configured to be executed in response to predefined triggers, without the need for provisioning or managing servers. When a trigger occurs, the serverless event-driven compute dynamically allocates the necessary resources and executes the function.

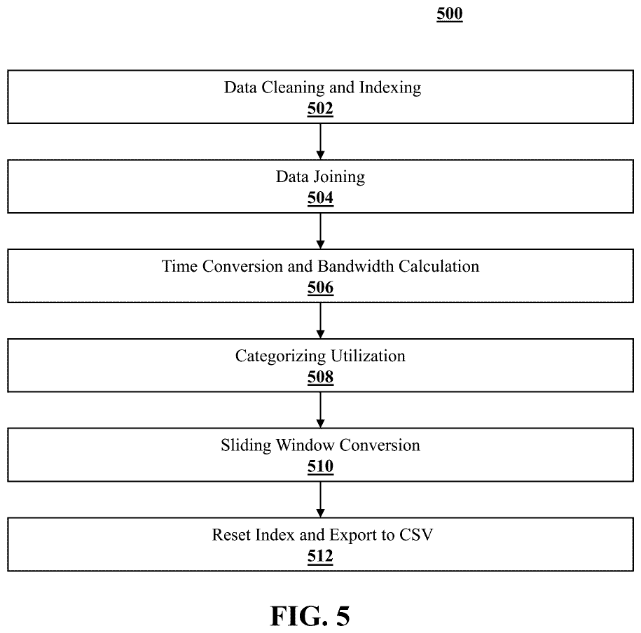

Upon execution completion, the processed data can be seamlessly written to a distributed data store 106. Distributed data store 106 can be a scalable object storage service such as Amazon S3, or another service with high availability, fault tolerance, and scalability, ensures that data is securely stored, easily retrievable, and ready for subsequent analysis and processing. This integration of stream processor, serverless function, and distributed data store creates a robust, efficient, and scalable data processing pipeline to implement the novel processes described herein. Next, a series of transformational steps occurs, as discussed in detail below regarding FIG. 5.

According to an embodiment, in a series of steps, the telemetry data is first cleaned by removing any NaN values. Next, specific indices are set for both telemetry and inventory data. These indices are essential for subsequent joining operations. By setting appropriate indices, telemetry and inventory data are joined in a manner which provides a more comprehensive dataset that includes both dynamic telemetry data and static inventory details. According to a further embodiment, the ‘hash’ attributes is dropped. Other unnecessary attributes may also be dropped at this stage.

According to an embodiment, a ‘starttime’ attribute is converted from a numerical representation to a human-readable timestamp. Next, bandwidth utilization is computed based on the ‘sum’ and ‘count’ attributes. According to an embodiment, this calculation represents the average bandwidth utilization in Mbps, normalized by the ‘totalmaxspeed’.

Next, a categorization of bandwidth utilization is performed. In one embodiment, utilization levels are divided into three categories: ‘well utilized’, ‘moderately utilized’, and ‘under-utilized’. This categorization can provide a higher-level insight into how effectively the network resources are being used.

According to an embodiment, the ‘slidingwindowsize’ attribute is transformed into an understandable format, representing the window size in hours or minutes. This conversion allows for better understanding and potential further time-series analysis.

Next, the processed data is reset to a default index and can be exported to CSV format. CSV is a widely accepted and easily readable data format that can be readily consumed by various tools and platforms. The processed data is subsequently stored in a dedicated repository referred to transformed data storage 112. This data is then primed for further processing through an LLM (Large Language Model) processing unit 114 and cached in “cache storage 118” for expedited access.

To facilitate user interaction and access to this data, a user interface labeled as “user interface 120” is provided. This interface seamlessly connects with a Flask middleware or an API endpoint 118.” This middleware/API endpoint serves as a gateway, enabling users to retrieve results from the cache, as elaborated upon below.

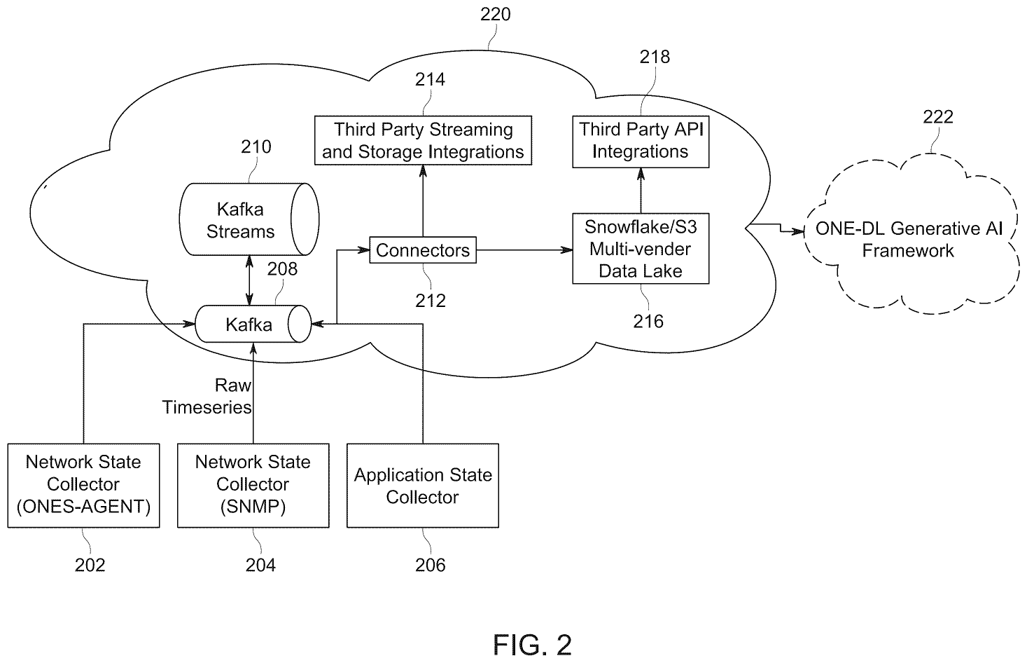

By way of example, FIG. 2 is a process architecture implemented in accordance with an embodiment of the current disclosure. Here, the stream producer 208, specifically an Apache Kafka instance, is initiated to serve as the primary channel for the intake of real-time data concerning network and application state telemetry. This data is sourced primarily from a set of network state collectors, namely ONES-AGENT (collector 202) and SNMP (collector 204), in addition to an application state collector 206. This setup ensures efficient and centralized data aggregation from these varied sources. In this configuration, the collectors 212 are initiated to acquire metrics and logs and to offer insights into system operational status. Kafka element 208 is responsible the facilitation of data flow through pre-defined connectors and Streams, thus enabling an array of data manipulations, including filtering, transformation, and enrichment.

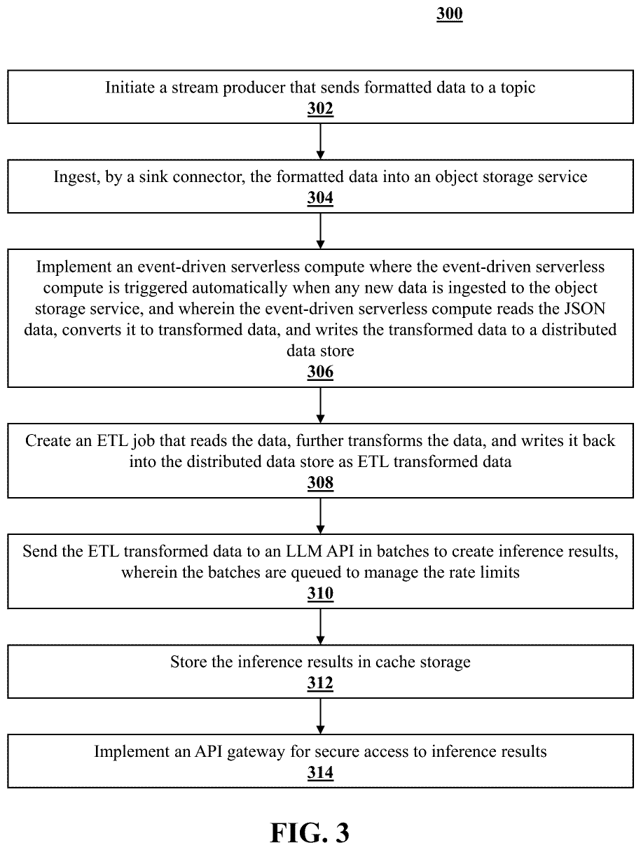

Streams 210 are tasked with real-time data processing, designed to handle data transformation requirements. The ecosystem seamlessly interfaces with external systems, enabling the real time flow of processed data to specialized analytics, reporting, and machine learning tools, as described in FIGS. 3-5.

In this defined architecture, connectors 212 are configured to ensure data is rendered into precise formats and structures, optimized for downstream processing and analyses. One or more connectors 212 acts as a bridge between the stream producer 208 and the data Snowflake or S3 Multi-vendor data lake 216, ensuring that data is reliably and efficiently transmitted from the source to the destination. This can include using a sink connector as a bridge between stream producer 208 and multi-vendor data lake 216.

In one embodiment, data lake 206 comprises a cloud-agnostic database system, originating from both on-premises and cloud sources, wherein it organizes and stores data in tabular formats that are readily consumed by observability applications. AI/ML applications can directly access this data, enabling them to derive intricate patterns and insights, which are instrumental for tasks like alert generation, predictive analytics, forecasting, and automated troubleshooting.

According to an embodiment, data ingestion is handled by a publish-subscribe messaging system, which consumes the bandwidth telemetry data published to a Kafka topic at the producer level. The data can then be encapsulated as JSON arrays and be published in real time. This type of architecture offers a robust and scalable platform for real-time data streaming, enabling the smooth ingestion of large data volumes.

By way of example, FIG. 3 is a flowchart of a process 300 of creating a generative AI framework on network state telemetry. As shown in FIG. 3, process 300 may include initiating a stream producer that sends formatted data to a topic (block 302). For instance, the stream producer might be Apache Pulsar, Amazon Kinesis, or Apache Kafka, sending formatted data to a topic, as previously explained. Using a stream producer offers several including the efficient and continuous transmission of data, and scalability by allowing network systems to handle growing data volumes by distributing the load across multiple servers or clusters. According to an embodiment, Publish/Subscribe (pub sub) Consumers are utilized consume the bandwidth telemetry data published to a Kafka topic at the producer level. According to an embodiment ingested data is encapsulated as JSON arrays and is published in real time. It can be appreciated that this type of data ingestion offers a robust and scalable platform for real-time data streaming, enabling the smooth ingestion of large data volumes.

Utilizing sink connector object store, the ingested data is then transferred to Amazon S3. This sink connector acts as a bridge between the Consumers and the object storage, ensuring that data is reliably and efficiently transmitted from the source to the destination. The integration between pub sub and object store provides data integrity without significant loss of information.

As also shown in FIG. 3, process 300 may include ingesting, by a sink connector, the formatted data into an object storage service (block 304). Such an integration between pub sub and object store data provides integrity without significant loss of information. Object storage can be implemented through Amazon S3, as well as alternative solutions like Google Cloud Storage, Microsoft Azure Blob Storage, and IBM Cloud Object Storage. For example, the device may ingest, by a Pub Sub native object store sink connector, the formatted data into Amazon S3, as described above. According to an embodiment, S3 serves as the sink for the data consumed by Kafka, where it is stored in a structured and organized manner as and when the data is written to the s3 bucket in batches.

As further shown in FIG. 3, process 300 may include processing and transformation steps by implementing an event-driven serverless compute configured to be triggered automatically when any new data is ingested to the object storage service (block 306). According to an embodiment, the event-driven serverless compute reads the data in its native format, converts it to transformed data, and writes the transformed data to a distributed data store. According to an embodiment of the disclosure, the method may implement an eventdriven serverless compute by implementing an AWS Lambda function, where the eventdriven serverless compute is triggered automatically when any new data is ingested to the object storage service, and where the event-driven serverless compute reads the JSON data, converts it to transformed data, where transformed data is in the CSV format (CSV transformed data), and writes the CSV transformed data to a distributed data store, as described above.

It can be appreciated that utilizing a serverless architecture as described herein eliminates the need for manual intervention, thus enabling seamless and efficient execution of code in reaction to the stream producer. Other embodiments may implement an event-driver serverless compute by using Google Cloud Functions, Microsoft Azure Functions, and IBM Cloud Functions, among others. The processing and transformation phase is a crucial step in preparing the raw data for modeling. This phase includes operations such as data cleaning, transformation, joining, and computation. Such an architecture allows for scalable execution and separation of concerns, where a dedicated machine learning service focuses only on training.

Once preprocessing and transformation are completed, the prepared data is written back to object storage. Storing the transformed data in object storage ensures that it is accessible to other components of the pipeline, such as SageMaker for training and inference. As also shown in FIG. 3, process 300 may include creating an ETL job, where the ETL job reads the data, further transforms the data, and writes it back into the distributed data store as ETL transformed data (block 308). For example, device may create a glue job, where the glue job reads the data, further transforms the data, and writes it back into the distributed data store as ETL transformed data, as described above. As further shown in FIG. 3, process 300 may include sending the ETL transformed data to an LLM API in batches to create inference results, where the batches are queued to manage the rate limits (block 310).

According to an embodiment, the transformed data is used for training the model and inference tasks are on demand. When the user asks a question in the UI, only then does the system send to the LLM API for inference and generate the response for the question.

Model training is an important part of the data pipeline that leverages the preprocessing and transformation stages to prepare and optimize the model for inference. According to an embodiment, model training encompasses two significant phases: the utilization of generative AI capabilities to pandas (by using a tool such as PandasAI), and data analysis and manipulation by, for example, LangChain for domain-specific applications. The training process has been designed to be incremental and decoupled from the inference, providing scalability and adaptability.

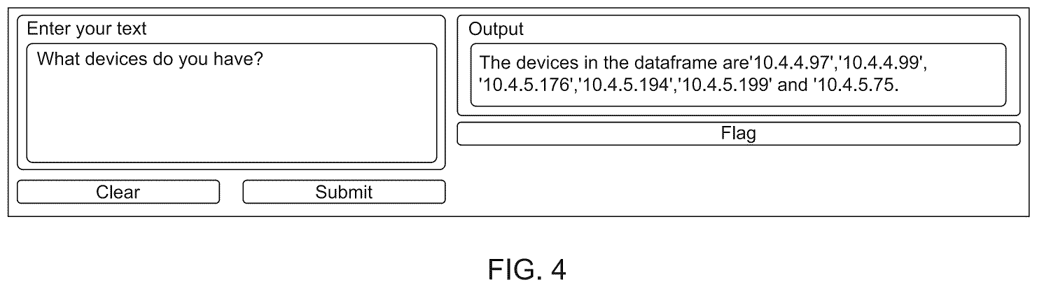

The LangChain platform can be utilized to execute the method's specific steps for domain-specific applications. This step includes a main model training process. In one embodiment, Dask is utilized to handle the parallelization of reading data, which can be of a considerable size, ranging into gigabytes or terabytes, ensuring both speed and efficiency. The data is then compiled into a unified pandas DataFrame, prepared for interaction with the LangChain's Pandas Dataframe agent. Utilizing such a modular architecture facilitates customization, allowing the creation of an agent that can engage with the data in English, as shown in FIG. 4. It transforms natural language queries into pandas commands, delivering human-like responses. According to an embodiment, training data is loaded into the agent.

By separating the training and inference processes in the methods described herein, the system gains flexibility. This separation means that changes or improvements to the training process can be made without affecting the existing inference functionality. It also facilitates parallel development and testing. The architecture supports scalability, allowing for the handling of ever-increasing data sizes and complexity. The system can grow with the needs of the organization without significant re-engineering.

For example, the process may include sending the ETL transformed data to an LLM API in batches to create inference results, where the batches are queued to manage the rate limits, as described above. As also shown in FIG. 3, process 300 may include storing the inference results in cache storage (block 312). Caching plays a crucial role in enhancing data retrieval processes, significantly improving application performance. By storing frequently accessed data in memory, which is much faster than traditional disk storage, applications can retrieve data at accelerated speeds, ensuring a smooth and responsive user experience. This capability is particularly beneficial during high-traffic periods, as cache supports stable performance and prevents slowdowns. Furthermore, by reducing the need for redundant API calls to the LLM, caching not only optimizes speed but also contributes to cost efficiency.

In addition to augmenting speed and cost-effectiveness, caching alleviates the workload on backend databases. This is achieved by reducing the number of direct data requests, minimizing the risk of database slowdowns or crashes during peak usage times. Caching in this manner is particularly advantageous for popular data profiles or items, preventing the overexertion of database resources. With the capacity to handle a multitude of data actions simultaneously, a well-implemented cache system ensures consistent, reliable performance, enhancing the overall efficiency and responsiveness of applications.

Once the training data has been loaded into the Agent, it is ready to be deployed. According to an embodiment, an Amazon Sagemaker Notebook Instance is used to deploy the endpoint. The user query is routed to the API endpoint to be run on the Agent. The generated response is then returned to the user.

It can be appreciated that by using such an approach, the model displays a commendable precision in its response generation. The model proficiently delivers precise answers for queries related to general knowledge. The model has successfully addressed prior challenges like extended training durations and delivering partial or erroneous responses.

As further shown in FIG. 3, process 300 may include implementing an API gateway for secure access to inference results (block 314). For example, the process may implement an API gateway for secure access to inference results, as described above. Process 300 may include additional implementations, such as any single implementation or any combination of implementations described below and/or in connection with one or more other processes described elsewhere herein. In a first implementation, the ETL is triggered whenever the transformed data is added to the distributed data store. In one embodiment, transformed data comprises a file in CSV file format.

In a second implementation, alone or in combination with the first implementation, the distributed data store further may include a cloud storage container.

In a third implementation, alone or in combination with the first and second implementation, the object storage service further may include a multi-vendor data lake.

In a fourth implementation, alone or in combination with one or more of the first through third implementations, cache storage is used for repeated calls to the API gateway.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

FIG. 4 discloses a response from the Agent. According to an embodiment of the present disclosure, to mitigate the recurring need to access the complete dataset, a double buffering method is employed. This approach entails maintaining two files for an API endpoint, though only one remains active at any given time. Given the periodic receival of fresh data, one file operates using the preceding data. Concurrently, the updated dataset—comprising both old and new data—is processed in the second file. While the Agent prepares to accommodate the new data, incoming queries are directed to the initial file. Once the Agent has assimilated the new data, query routing is switched to the second file. The previously secondary file now operates on the new dataset, and the cycle continues. This mechanism efficiently sidesteps the issue of constant large-scale data retrieval.

FIG. 5 is a flowchart of an example process 500. In some implementations, one or more process blocks of FIG. 5 may be performed by a device.

As shown in FIG. 5, process 500 may include Data cleaning and Indexing (block 502). For example, telemetry data is cleaned by removing any NaN values, and specific indices are set for both telemetry and inventory data. These indices are essential for subsequent joining operations, as described above. As also shown in FIG. 5, process 500 may include Data Joining (block 504). By setting appropriate indices, telemetry and inventory data are joined seamlessly. This joining provides a more comprehensive dataset that includes both dynamic telemetry data and static inventory details. Unnecessary attributes like ‘hash’ are also dropped.

As further shown in FIG. 5, process 500 may include Time Conversion and Bandwidth Calculation (block 506). For example, the ‘starttime’ is converted from a numerical representation to a human-readable timestamp. The bandwidth utilization is computed based on the ‘sum’ and ‘count’ attributes. This calculation represents the average bandwidth utilization in Mbps, normalized by the ‘totalmaxspeed’. As also shown in FIG. 5, process 500 may include Categorizing Utilization (block 508). According to an embodiment, a categorization of bandwidth utilization is performed. Utilization levels are divided into three categories: ‘well utilized’, ‘moderately utilized’, and ‘under-utilized’. This categorization provides a higher-level insight into how effectively the network resources are being used. As illustrated in FIG. 5, process 500 further encompasses the steps of resetting the Index and exporting to a CSV file (see block 512). In this phase, the processed data is reverted to a standard index and then exported in CSV format. For instance, the method may perform the index reset and CSV export immediately after categorizing utilization, as previously outlined.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. What has been described and illustrated herein is an example along with some of its variations. The terms, descriptions and figures used herein are set forth by way of illustration only and are not meant as limitations.

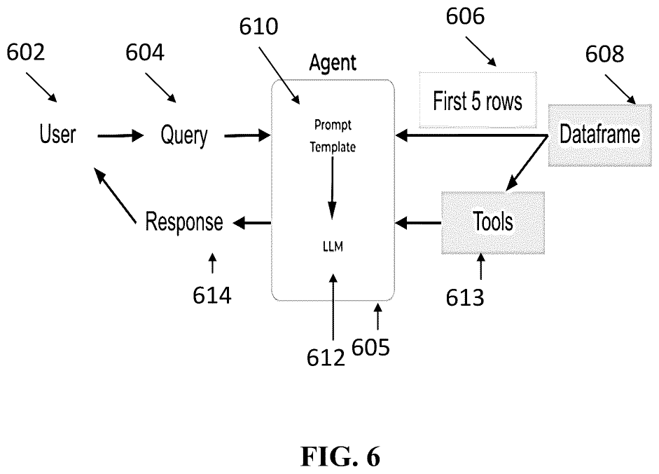

FIG. 6 discloses an agent architecture according to an embodiment of the present disclosure.

When a user 602 presents a query 604, the initial entries 606 from the dataframe 608 serve as contextual information, appended to the suffix of the prompt directed to the Large Language Model (LLM). Subsequently, a standardized prompt template 610 is constructed, embedding the user's original query 604 within it. For example, the prompt template can be a formatted prompt. This prompt template is then channeled to the LLM 612. The dataframe 608 also provides tools 613 to the agent 605 to aid in shaping the ultimate reply.

According to an embodiment, the LLM 612 offers directives to the agent 605, specifying the precise pandas commands to execute in order to formulate an appropriate response 614 to the user's inquiry. The response 614 is then output as a human-like response. According to an embodiment, these commands are executed within a python environment.

In the proposed system, the agent's functionalities can be effectively executed either by one or more dedicated processors or within a cloud-based architecture. When operated through processors, the agent harnesses the computational power and specialized capabilities of these processors to perform its tasks with high efficiency and precision. This local execution method offers the advantage of reduced latency and enhanced data security, as the processing is done on-site. Alternatively, when deployed in a cloud-based architecture, the agent benefits from the expansive computational resources and scalability that cloud environments offer. This cloud-based approach enables the agent to handle large-scale data processing and complex algorithms, while also offering the flexibility of remote access and maintenance. The choice between processor-based and cloud-based execution depends on factors such as the required computational power, data sensitivity, and scalability needs of the system, allowing for a tailored approach that best suits the operational requirements.

According to an embodiment, one or more processes are provided for LLM training for network state conversational analytics. In an embodiment, Pandas AI is utilized to execute generative AI models configured to allow users to glean insights from data frames using just a text prompt by leveraging text-to-query generative AI. It can be appreciated that this configuration streamlines data preparation, which has been traditionally time-consuming for data experts.

According to an embodiment, instead of manually navigating datasets, users can pose questions to PandasAI, receiving answers in Pandas DataFrame format. It can be appreciated that this approach may eliminate manual coding. According to an embodiment, a GPT API is utilized to autonomously generate and execute code using the Pandas library in Python, wherein the GPT API returns results that can be stored in variables.

As described above, according to an embodiment, processed data in CSV format is fed as a Pandas dataframe as the input to the model. Alternative embodiments may utilize another text-based data format in place or in addition to CSV format. According to an embodiment, an LLM is also provided to Pandas AI. Next, Pandas AI accepts the dataframe and a user query, which it then forwards to a suite of Large Language Models (LLMs). Utilizing a GPT API in the background (such as Chat GPT), Pandas AI generates the desired code and executes it, according to an embodiment. The resulting output, post-execution, is then relayed back to the user.

According to an embodiment, some of the tools 613 may further comprise the following tools.

Automated Data Cleaning and Preprocessing: The pandas AI dataframe can automatically handle missing values, outliers, and format inconsistencies, making the data more suitable for analysis by the LLM.

Natural Language Query Processing: The LLM can interpret natural language queries about the data, allowing users to ask questions in plain English and receive insights without needing to write complex code.

Advanced Data Analysis: Leveraging the LLM's capabilities, the tool can perform sophisticated data analysis, including trend identification, pattern recognition, and predictive modeling.

Data Visualization: The integration can automatically generate charts, graphs, and other visual representations of data in response to natural language requests.

Textual Data Interpretation: The LLM can extract and interpret qualitative data, converting text-based information into quantitative insights that can be analyzed alongside numerical data.

Sentiment Analysis: For datasets containing textual information, the LLM can perform sentiment analysis, providing insights into the opinions or emotions expressed in the data.

Data Summarization: The tool can produce concise summaries of large datasets, highlighting key points and trends in an easily digestible format.

Predictive Modeling and Forecasting: Utilizing the LLM's advanced algorithms, the tool can build predictive models and make forecasts based on historical data trends. Customizable Data Transformations: Users can instruct the LLM to perform specific data transformations or calculations using natural language commands.

Anomaly Detection: The integration can automatically detect and flag anomalies in the data, which could indicate errors or important insights.

Data Enrichment: The LLM can suggest and potentially automate the process of enriching the dataset with additional relevant data from external sources.

Contextual Data Interpretation: The LLM can provide context and background, helping to interpret data within a broader framework or specific domain knowledge.

It can be appreciated that such a configuration provides for easy interfacing with language models and provides ready-made chains for common tasks. While pre-configured chains facilitate a quick start, individual components allow for customization and creation of new configurations as per specific needs.

The system can use domain-specific data and is able to answer queries with minimal human intervention. It enables advanced querying of large datasets with great efficiency and comparatively low latency. It enables us to converse with our data in English instead of writing queries, making query writing redundant and making it accessible for people with no querying knowledge to get insights on their data.

According to an embodiment the architecture makes use of function calling functionality to choose the correct agent for the query. It can be appreciated that this enables the architecture to support either one agent or multiple agents if needed.

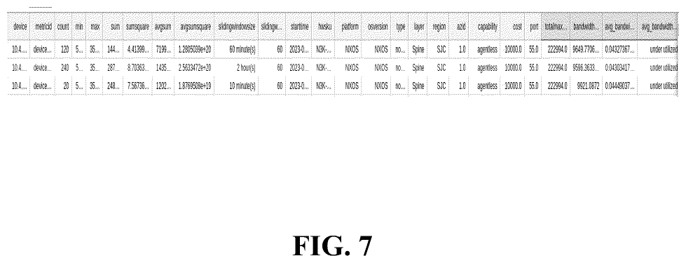

FIG. 7 is a snapshot of training data according to an embodiment of the present disclosure. The system ingests unprocessed CSV files as its primary input, akin to the snapshot of training data presented as FIG. 7. These files encompass columns detailing aspects such as average bandwidth utilization, associated labels, and other pertinent data. The system collates all the CSV files and channels them as a unified pandas dataframe, which is subsequently delivered to the Agent.

According to an embodiment, the system utilizes the Dask python library to speed up the reading process. Dask is a Python library optimized for parallel processing, seamlessly merging with libraries like Pandas and NumPy.

We set the temperature to zero to get the most accurate response. Once we feed in the data to the Agent, it is ready for inference.

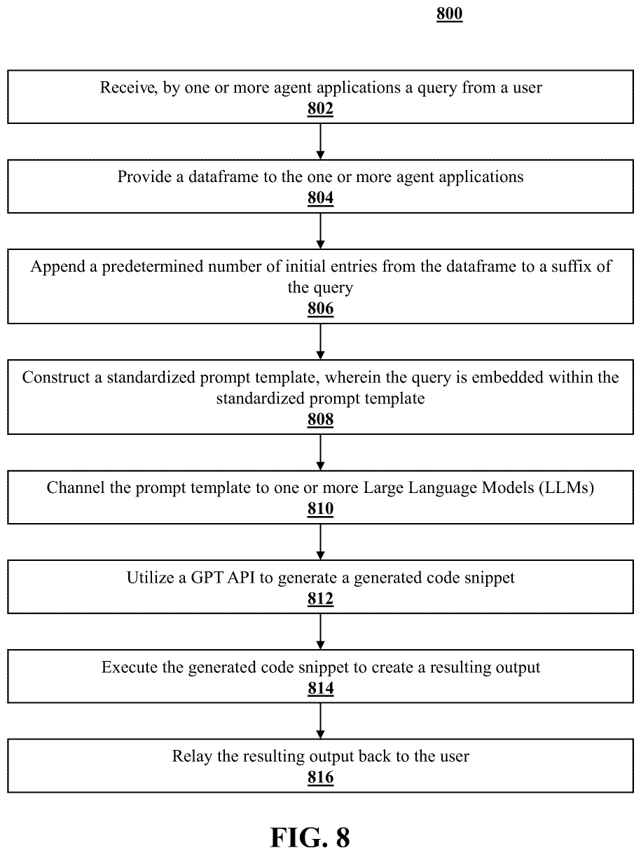

FIG. 8 is a flowchart of an example process 800. In some implementations, one or more process blocks of FIG. 8 may be performed by a non-transitory computer-readable medium.

As shown in FIG. 8, process 800 may include receiving, by one or more agent applications, a query from a user (block 802). For instance, a non-transitory computerreadable medium can be employed to receive queries from users through one or more agent applications. These agent applications are designed to interface with the user, allowing them to input their queries in various formats. As also shown in FIG. 8, process 800 may include providing a dataframe to the one or more agent applications (block 804). For instance, in the described system, a non-transitory computer-readable medium can supply a ‘Pandas AI dataframe’ to one or more agent applications. This Pandas AI dataframe, a sophisticated data structure, is specifically designed to cater to the advanced analytical needs of these applications. It integrates seamlessly with the agent applications, providing them with rich, structured data that can be efficiently manipulated and analyzed. The dataframe's design incorporates AI-enhanced capabilities, enabling more nuanced data interpretation and processing. This integration forms a crucial part of the system, ensuring that the agent applications have access to high-quality, well-organized data, which is essential for effective decision-making and analytical processes.

As further shown in FIG. 8, process 800 may include appending a predetermined number of initial entries from the dataframe to a suffix of the query (block 806). For example, non-transitory computer-readable medium may append 5 initial entries from the dataframe to a suffix of the query, as described above. As also shown in FIG. 8, process 800 may include constructing a standardized prompt template (block 808). For example, non-transitory computer-readable medium may construct a standardized prompt template, where the query is embedded within the standardized prompt template, as described above.

As further shown in FIG. 8, process 800 may include channeling the prompt template to one or more Large Language Models (LLMs) (block 810). For example, non-transitory computer-readable medium may channel the prompt template an OpenAI LLM. As also shown in FIG. 8, process 800 may include Utilizing a GPT API to generate a generated code snippet (block 812). As further shown in FIG. 8, process 800 may include executing the generated code snippet to create a resulting output (block 814). For example, in the system outlined previously, a non-transitory computer-readable medium plays a crucial role in executing generated code snippets. These snippets, created because of various computational processes or user inputs, are efficiently processed by the medium. Upon execution of these code snippets, the medium effectively translates the coded instructions into actionable tasks, leading to the generation of a specific output. This output could range from simple data representations to complex algorithmic solutions, depending on the nature and complexity of the code snippet. The ability of the non-transitory computer-readable medium to execute these snippets accurately and efficiently is vital, as it directly impacts the quality and reliability of the resulting output. This execution process is integral to the system's functionality, providing a seamless transition from code generation to the realization of tangible, useful outcomes.

As also shown in FIG. 8, process 800 may include relaying the resulting output back to the user (block 816). Once the medium has successfully processed and executed the necessary operations, it generates an output. This output, which is the culmination of the computational tasks performed, is then communicated back to the user. The medium ensures that this transmission is done efficiently and accurately, maintaining the integrity and relevance of the information being conveyed. This feedback mechanism is essential in closing the loop of the user's interaction with the system, providing them with the information or results they requested. The ability to relay outputs back to the user in a clear, concise, and timely manner is a critical component of the system, enhancing user experience and facilitating effective communication between the user and the computational processes.

Process 800 may include additional implementations, such as any single implementation or any combination of implementations described below and/or in connection with one or more other processes described elsewhere herein. A first implementation, process 800 may include specifying one or more pandas commands to execute to formulate an appropriate response to the query.

In a second implementation, alone or in combination with the first implementation, the receiving further may include receiving processed data in CSV format.

In a third implementation, alone or in combination with the first and second implementation, the relaying is done post-execution.

A fourth implementation, alone or in combination with one or more of the first through third implementations, process 800 may include setting a temperature of the one or more large language models to zero.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

While the detailed description above has presented novel features in relation to various embodiments, it is important to acknowledge that there is room for flexibility, including omissions, substitutions, and modifications in the design and specifics of the devices or algorithms illustrated, all while remaining consistent with the essence of this disclosure. It should be noted that certain embodiments discussed herein can be manifested in various configurations, some of which may not encompass all the features and advantages expounded in this description, as certain features can be implemented independently of others. The scope of the embodiments disclosed here is defined by the appended claims, rather than the preceding exposition. All alterations falling within the meaning and range of equivalence of the claims are to be encompassed within their ambit.

What is claimed is:

1. A method, comprising:
receiving, by one or more agent applications a query from a user; providing a dataframe to the one or more agent applications; appending a predetermined number of initial entries from the dataframe to a suffix of the query; constructing a standardized prompt template, wherein the query is embedded within the standardized prompt template;
channeling the standardized prompt template to one or more Large Language Models (LLMs); utilizing a GPT API to generate a generated code snippet;
executing the generated code snippet to create a resulting output;
and relaying the resulting output back to the user.

2. The method of claim 1, further comprising specifying one or more pandas commands to execute in order to formulate an appropriate response to the query.

3. The method of claim 1 wherein the relaying is done post-execution.

4. The method of claim 2, wherein the receiving further comprises receiving processed data in CSV format.

5. The method of claim 3, further comprising setting a temperature of the one or more large language models to zero.

6. A non-transitory computer-readable medium storing a set of instructions, the set of instructions comprising:
one or more instructions that, when executed by one or more processors of a device, cause the device to:
receive, by one or more agent applications a query from a user; provide a dataframe to the one or more agent applications; append a predetermined number of initial entries from the dataframe to a suffix of the query; construct a standardized prompt template, wherein the query is embedded within the standardized prompt template;
channel the standardized prompt template to one or more Large Language Models (LLMs); utilize a GPT API to generate a generated
code snippet; execute the generated code snippet to
create a resulting output; and relay the resulting output
back to the user.

7. The non-transitory computer-readable medium of claim 6, wherein the one or more instructions further cause the device to:
specify one or more pandas commands to execute in order to formulate an appropriate response to the query.

8. The non-transitory computer-readable medium of claim 7, wherein the one or more instructions cause the device to receive processed data in CSV format.

9. The non-transitory computer-readable medium of claim 6, wherein the relaying is done post-execution.

10. The non-transitory computer-readable medium of claim 9, wherein the one or more instructions further cause the device to:
set a temperature of the one or more large language models to zero.

11. A system comprising:
one or more processors configured to:
receive, by one or more agent applications a query from a user;
provide a dataframe to the one or more agent applications; append a predetermined number of initial entries from the dataframe to a suffix of the query; construct a standardized prompt template, wherein the query is embedded within the standardized prompt template;
channel the standardized prompt template to one or more Large Language Models (LLMs);
utilize a GPT API to generate a generated code snippet;
execute the generated code snippet to create a resulting output; and
relay the resulting output back to the user.

12. The system of claim 11, further comprising specifying one or more pandas commands to execute in order to formulate an appropriate response to the query.

13. The system of claim 12, wherein the receiving further comprises receiving processed data in CSV format.

14. The system of claim 11, wherein the relaying is done post-execution.

15. The system of claim 14, further comprising setting a temperature of the one or more large language models to zero.
